(19) United States
(12) Patent Application Publication
(10) Pub. No.: US 2023/0103997 A1
(43) Pub. Date: Apr. 6, 2023

(54) INTEGRATING SPATIAL LOCALITY INTO IMAGE TRANSFORMERS WITH MASKED ATTENTION

(71) Applicant: Samsung Electronics Co., Ltd., Suwon-si (KR)

(72) Inventors: Ling LI, Sunnyvale, CA (US); Ali SHAFIEE ARDESTANI, Santa Clara, CA (US); Joseph H. HASSOUN, San Jose, CA (US)

(21) Appl. No.: 17/573,630

(22) Filed: Jan. 11, 2022

Related U.S. Application Data
(60) Provisional application No. 63/252,573, filed on Oct. 5, 2021.

(51) Int. Cl. G06V 10/82; G06T 5/20; G06T 3/40; G06V 10/74; G06V 10/88

(52) U.S. Cl. CPC G06V 10/82; G06T 5/20; G06T 3/4046; G06V 10/761; G06V 10/88

(57) ABSTRACT

A vision transformer includes L layers, and H attention heads in each layer. An h′ of the attention heads include an attention mask added before a Softmax operation, and an h of the attention heads include unmasked attention heads in which H=h′+h. Each attention mask multiplies a Query vector and a Key vector for form element-wise products. At least one attention mask is a hard mask that selects closest neighbors of a patch and ignores patches further away than the closest neighbors of the patch. Alternatively, at least one attention mask includes a soft mask that multiplies weights of closest neighbors of a patch by a magnification factor and passes weights of patches that are further away than the closest neighbors of the patch. A learnable bias α may be added to diagonal elements of the at least one attention map.

### CROSS-REFERENCE TO RELATED APPLICATION

This application claims the priority benefit under 35 U.S.C. § 119(e) of U.S. Provisional Application No. 63/252,573, filed on Oct. 5, 2021, the disclosure of which is incorporated herein by reference in its entirety.

### TECHNICAL FIELD

The subject matter disclosed herein relates to an image transformer. More particularly, the subject matter disclosed here relates to an image transformer that includes attention masks and a method for determining where to add attention masks in an image transformer according to the subject matter disclosed herein.

### BACKGROUND

Convolutional neural networks (CNN), which are inherently equipped with inductive biases such translation equivariance and locality, have been a de facto model for computer vision (CV) tasks. Recently, vision transformers have gained momentum translating the success from transformer-based models in natural language processing (NLP) tasks.

### SUMMARY

An example embodiment provides a vision transformer that may include L layers, and H attention heads in each layer in which h′ of the attention heads may include an attention mask added before a Softmax operation, and h of the attention heads may include unmasked attention heads, and in which H=h′+h. In one embodiment, at least one attention mask multiplies a Query vector and a Key vector for form element-wise products. In another embodiment, at least one attention mask may be a 3×3 attention mask. In still another embodiment, at least one attention mask may be a 5×5 attention mask. In yet another embodiment, at least one attention mask may include a hard mask that selects closest neighbors of a patch and ignores patches further away than the closest neighbors of the patch. In one embodiment, at least one attention mask may include a soft mask that multiplies weights of closest neighbors of a patch by a magnification factor and passes weights of patches that are further away than the closest neighbors of the patch. In another embodiment, a learnable bias α is added to at least one attention mask. In still another embodiment, the learnable bias α is added to diagonal elements of the at least one attention map.

An example embodiment provides a method of integrating spatial locality into an image transformer in which the method may include: adding an attention mask to a selected attention head in each layer of the image transformer; determining an attention locality score for each layer of the image transformer; adding an attention mask to all attention heads of a layer based on the attention locality score for the layer being greater than 0.75; adding no more attention masks to a layer based on the attention locality score for the layer being greater than or equal to 0.35 and less than or equal to 0.75; and removing the attention mask from a layer based on the attention locality score for the layer being less than 0.35. In one embodiment, adding the attention mask to the selected attention head in each layer of the image transformer may include adding the attention head before a Softmax operation. In another embodiment, adding an attention mask to all attention heads of a layer based on the attention locality score for the layer being greater than 0.75 may further include: determining an attention locality score for each attention head in the layer, and removing the attention mask from an attention head based on the attention locality score being less than 0.35. In still another embodiment, at least one attention mask may be a 3×3 attention mask. In yet another embodiment, at least one attention mask may include a 5×5 attention mask. In one embodiment, at least one attention mask may include a hard mask that selects closest neighbors of a patch and ignores patches further away than the closest neighbors of the patch. In another embodiment, at least one attention mask may include a soft mask that multiplies weights of closest neighbors of a patch by a magnification factor and passes weights of patches that are further away than the closest neighbors of the patch. In still another embodiment, the method may further include adding a learnable bias α to at least one attention mask. In yet another embodiment, the method may further include the learnable bias α is added to diagonal elements of the at least one attention map. In still another embodiment, the method may further include using a cross-layer cosine similarity to evaluate an impact of at least one attention masks across at least two layers of the image transformer.

### BRIEF DESCRIPTION OF THE DRAWING

In the following section, the aspects of the subject matter disclosed herein will be described with reference to exemplary embodiments illustrated in the figure, in which:

FIG. 1 depicts two examples of attention masks that have been mapped onto a 224×224 pixel image that has been split into 196 patches in which each patch includes 16×16 pixels according to the subject matter disclosed herein;

FIG. 2 depicts an MHA module having H attention heads in which an h′ number of attention heads may be grouped into a first module 201 that may be allocated to focus on local information, and the rest of the H−h′ unaltered (unmasked) attention heads may be grouped into a second module that capture global dependencies;

FIG. 3 is a flowchart of an example masking strategy method for determining where to add attention masks according to the subject matter disclosed herein;

FIG. 4 depicts a system for performing the example masking strategy method of FIG. 3 to determine where to add attention masks according to the subject matter disclosed herein;

FIGS. 5A and 5B respectively depict an example hard mask and an example soft mask according to the subject matter disclosed herein;

FIG. 6 depicts how soft masking may be applied to an attention head according to the subject matter disclosed herein; and

FIG. 7 depicts an electronic device that includes a virtual training system according to the subject matter disclosed herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The transformer architecture has inspired many model variants with remarkable success in NLP tasks. The Vision transformer (ViT) is the first pure transformer-based model for vision tasks and extends pure transformer-based architecture in CV applications. Instead of a pixel-level process, ViT splits the original images into a sequence of patches as inputs for better computation efficiency. A fundamental structure of ViT includes an embedding layer, a multi-head attention, and feed-forward network. Another architecture, the Data-efficient image transformer (DeiT), improves upon ViT models by introducing stronger data augmentation, regularization, and knowledge distillation.

To process images in a transformer, original (224×224) RGB images are flattened into a sequence of N patches. Each patch may have a fixed size, typically 14×14 or 16×16 pixels. Patches are then transformed into patch embedding having hidden dimensions (D) of 192, 384, and 768 for tiny, small, and base models, respectively, in ViT/DeiT. In addition to patch tokens, an embedding layer also respectively integrates positional information, classification and knowledge distillation through a positional token, a class token and a distillation token. The positional token is added into the patch embedding with a trainable positional embedding. The positional embedding, however, is added only in the embedding layers. The spatial information is largely lost in the transformer layers because all-to-all attention is invariant to the order of the patches. The class token is another trainable vector (1×D), and may be concatenated to the patch tokens. The class token may be used in the classifier to predict the class. The class token may collect information from the patch token to make output prediction, while also spreading information between patches during training. The distillation token may be applied for knowledge transfer from teacher models, such as a CNN or other more complicated models. When training the distilled version of the model, a distillation token may be further concatenated to the patch token along with the class token (total N+2). The distillation token may be complementary to the class token by providing extra information from the teacher model. At test time, the class token or the distillation token, or fusion of the two tokens, serve as an input to the linear classifier. A Multi-Head Attention (MHA) module includes three main components, a Key vector, a Query vector, and a Value vector. Key (N×d) and Query (N×d) may be trained and multiplied to estimate how much weights on each corresponding element in Value (N×d) for output (N×d):

$$Attention ( K ; Q ; V ) = Softmax ( \frac{Q {K}^{T}}{\sqrt{d}} ) V \qquad ( 1 )$$

in which the Softmax operation is applied to each row of the input matrix, d is the dimension of the Key, Query and Value vectors, and \sqrt{d} provides appropriate normalization. MHA includes multiple attention heads to attend different parts of the input simultaneously. Considering h heads in the MHA layer, the hidden dimension D is split equally across all heads with D=h×d.

A Feed-Forward Network (FFN) follows the MHA module and contains two linear transformation layers that are separated by a Gaussian Error Linear Unit (GeLU) activation. The hidden dimension expands by 4× after the first linear layer from D to 4D, and reduces back to D in the second linear layer. Both MHA and FFN use skip connections with layer normalization as the residual operation.

Spatial locality plays a crucial role in computer vision tasks. Convolutional Neural Network (CNN) models capture spatial locality using a sliding filter of shared weights, typically with a receptive field of 3×3, 5×5, or 7×7. In contrast to CNN models, locality is not explicitly introduced in a transformer structure. According to the subject matter disclosed herein, locality may be explicitly inserted into self-attention modules at each layer by using attention masks without introducing any extra parameters or computations. A key aspect is to apply a mask on the all-to-all attention products (i.e., QK^{T}) to reinforce weights (importance) of the closest neighbors and allow information aggregation only from tokens selected by the mask.

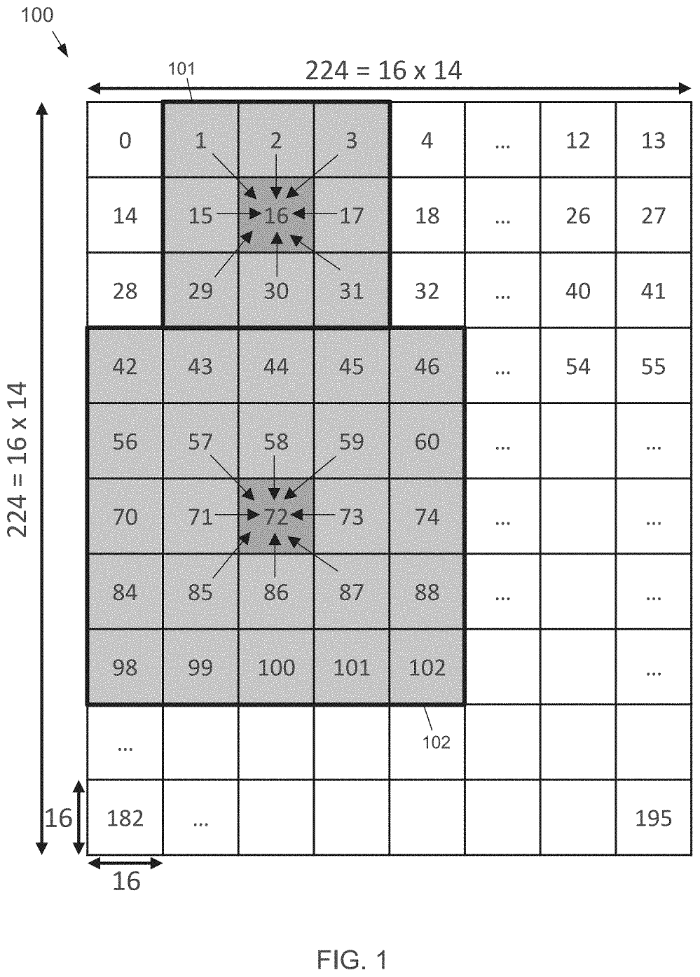

FIG. 1 depicts two examples of attention masks that have been mapped onto a 224×224 pixel image 100 that has been split into 196 patches in which each patch includes 16×16 pixels according to the subject matter disclosed herein. A first example attention mask 101 that is aligned with patch 16 is a 3×3 mask in which patches that are direct neighbors to patch 16 are selected. In particular, the 3×3 mask 101 aligned with patch 16 gathers information only from the closest neighbors to patch 16, which are patches 1, 2, 3, 15, 17, 29, 30, and 31, as indicated by the arrows pointing toward patch 16, while information from the rest of patches are ignored. This differs from a typical all-to-all attention module in which patch 16 would gather information from all 0-195 patches.

A second example attention mask 102 that is aligned with patch 72 is a 5×5 mask in which information is gathered for a patch by expanding the depth of the mask beyond directly neighboring patches to second-level neighbors. In particular, the 5×5 mask 102 aligned with patch 72 gathers information from patches 42-46, 56-60, 70, 71, 73, 74, 84-88 and 98-102.

The class token (and the distillation token) still attends to all the patches to collect and spread information during forward and backward passes. Each attention product may be selected by the mask, which is calculated by Q and K, so the masked attention head also retains the content-based locality information.

The attention mask is added before the Softmax operation, thereby regulating distribution of attention maps to focus on the closest neighbors of patches:

$$Masked Attention ( K , Q , V ) = Softmax ( \frac{M ⊙ {QK}^{T}}{\sqrt{d}} ) V \qquad ( 2 )$$

in which M∈ [symbol] ^{(N+1)×(N+1)} is a binary attention mask that encodes spatial locality into the attention head by passing through only the weights (importance) from locally close neighbors and setting the weights of the remaining patches to zero. More precisely, unselected patches appear as e⁰=1 in the numerator of the Softmax operation.

It is important to add the mask before the Softmax operation because it allows the model to learn the importance of the locality flexibly. Thus, if the result of the attention product of the closest neighbors is meaningfully larger than zero (i.e., M⊙QK^{T}>>0), then it tends to provide that local information dominates over global information.

If, however, the attention product results are negative or close to zero, it tends to suggest that local information is insignificant and global information is more important. Therefore, inserting masks before the Softmax operation allows models to enforce locality or ignore locality.

The Softmax operation transfers the QK^{T} product results into a probability space so that each row of the attention map (A) sums to 1. For each patch, the probability of focusing on local neighbors equals to the sum of the attention map weights of their neighbors. If this sum approaches one, the local information is crucial; whereas if the sum is close to zero, it means global information matters more than local information. An Attention Locality Score (ALSₙ) for patch n and the average ALS from all patches (N+1) for each attention head may be defined as:

$$ALS = \frac{{\sum }_{n} A L {S}_{n}}{( N + 1 )} in which {ALS}_{n} = {\sum }_{i} {( M ⊙ A )}_{n , i} \qquad ( 3 )$$

in which M is the binary attention mask described in connection with Eq. (2), A=Softmax(Mask⊙QK^{T}/\sqrt{d}) is the attention map for masked attention heads, and A=Softmax(QK^{T}/\sqrt{d}) is the attention map for unmasked attention heads, n is a patch index, and i is the column index of attention map. As used herein the symbol ⊙ is a Hadamard product, which is also known as an element-wise product. The ALS metric may be used to obtain insight about the locality behavior of different attention heads in the vision transformer model.

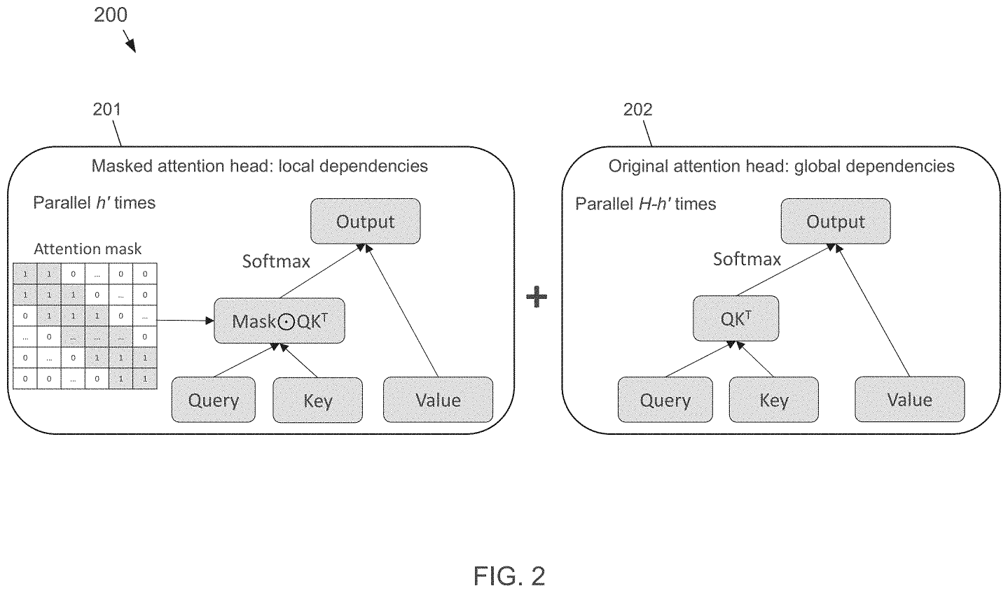

Local information may be extracted through a masked attention head while at the same time global information may be extracted through the original attention heads, as depicted in FIG. 2. That is, FIG. 2 depicts an MHA module 200 having H attention heads in which an h′ number of attention heads may be grouped into a first module 201 that may be allocated to focus on local information, and the rest of the H−h′ unaltered (unmasked) attention heads may be grouped into a second module 202 that capture global dependencies.

The different functional blocks within each of the first module 201 and the second module 202 may each be modules that provide the indicated function. For example, in the first module 201, the Query tokens, Key tokens and Value tokens may be respectively supplied by separate modules. The Mask⊙QK^{T} module may receive the attention mask and perform the Mask⊙QK^{T} prior to a Softmax module performing a Softmax operation, which is then supplied to an Output module. The second module 202 may include modules that are similar to the modules within the first module 201, except that no attention mask is received by a QK^{T} module.

Besides the depth of the attention mask, the number of masked attention heads in the MHA module 200 and the position (which layer to insert a mask) may also be hyper-parameters. As used herein, the term “hyper-parameter” is a parameter having a value that is used to control a learning process. Although masks encode locality into the attention heads, the regularization from masking, which operates like a pruning attention map, may limit the learning capacity of the MHA module. Consequently, where to add attention masks may involve careful consideration.

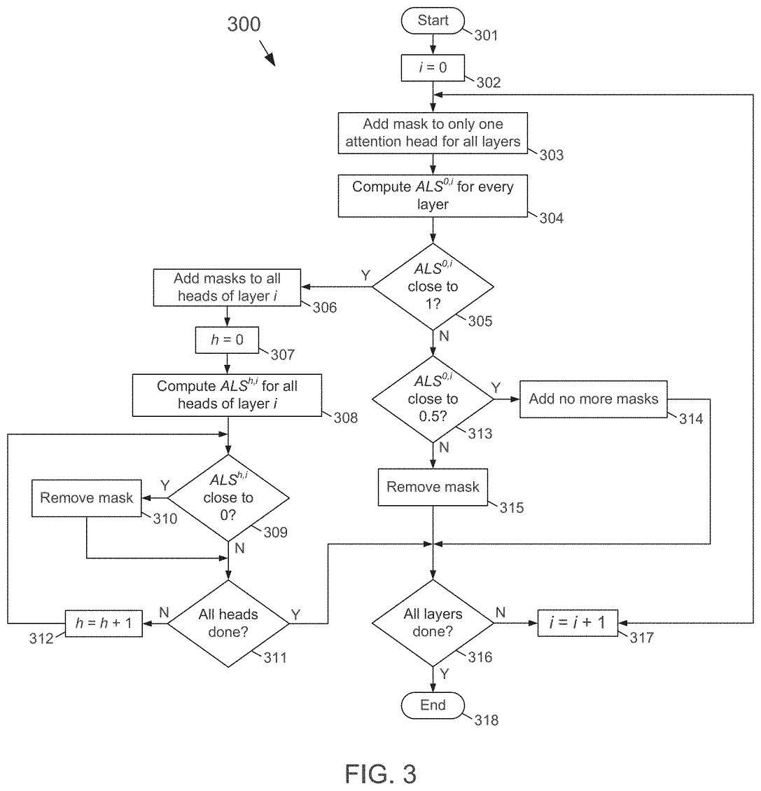

FIG. 3 is a flowchart of an example masking strategy method 300 for determining where to add attention masks according to the subject matter disclosed herein. The method 300 begins at 301. At 302, an index i is initialized to equal 0. At 303, an attention mask is added to only one attention head for all layers. For example, an attention mask is added to head 0 in all layers. At 304, ALS^{0,i} is computed for every layer. At 305, it is determined whether ALS^{0,i} is close to 1. In one embodiment, it may be determined at 305 whether ALS^{0,i} is greater than 0.75. In another embodiment, a threshold that is different from 0.75 may be used. If, at 305, it is determined that ALS^{0,i} is close to 1, flow continues to 306 where attention masks are added to all heads of layer i. Flow continues to 307 where index h is initialized to equal 0.

At 308, ALS^{h,i} is calculated for each head in layer i. At 309, where it is determined whether ALS^{h,i} is close to 0. In one embodiment, it may be determined at 308 whether ALS^{h,i} is less than 0.35. In another embodiment, a threshold that is different from 0.35 may be used. If, at 309, it is determined that ALS^{h,i} is close to 0, flow continues to 310 where the attention mask is removed from head h. Flow continues to 311. If, at 309, it is determined that ALS^{h,i} is not close to 0, flow continues to 311 where it is determined whether all heads of layer i have been evaluated. If not, flow continues to 312 where index h is incremented and flow returns to 309. If, at 311, it is determined at all heads of layer i have been evaluated, flow continues to 317.

If, at 305, it is determined that ALS^{0,i} is not close to 1, flow continues to 313 where it is determined whether ALS^{0,i} is close to 0.5. In one embodiment, it may be determined at 313 whether ALS^{0,i} is between 0.35 and 0.75, inclusive. In another embodiment, a different range may be used at 313 that is consistent with the thresholds used for determining whether ALS^{h,i} is close to 1 and close to 0. If at 313, it is determined that ALS^{h,i} is close to 0.5, flow continues to 314 where no more attention masks are added to the heads of layer i. Flow then continues to 316.

If, at 313, it is determined that ALS^{0,i} is not close to 0.5, flow continues to 315 where the single attention mask is removed from layer i. Flow then continues to 316.

At 316, it is determined whether all layer have been evaluated. If not, flow continues to 317 where the index i is incremented and flow returns 303. If, at 316, it is determined that all layers have been evaluated, flow continues to 318 where masking strategy method 300 ends.

In one embodiment, the threshold used at 308 may be 0.25, and the thresholds used at 313 may be 0.4 and 0.6. If a determination is made that falls in either of the two gaps between 0.25 and 0.4, and between 0.6 and 0.75, method 300 may query a user for an instruction regarding adding attention masks to all heads of layer i, adding no more attention masks to the heads of layer i, or removing the attention mask from head h.

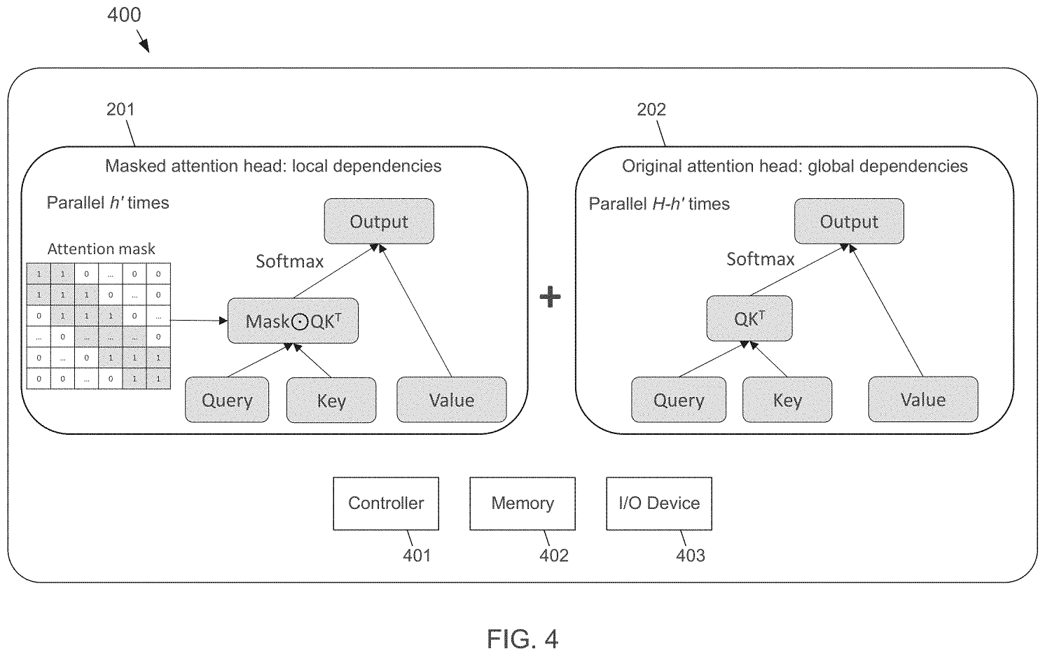

FIG. 4 depicts a system 400 for performing the example masking strategy method 300 to determine where to add attention masks according to the subject matter disclosed herein. The system 400 includes a controller 401, such as a microprocessor, a memory 402, and input/output (I/O) device 402, such as a display. In one embodiment, the controller 401 may execute instructions stored in the memory 402 to perform the example masking strategy method 300. The system 400 provides interim and final results through the I/O device 403. In another embodiment, the system 400 may be a state machine configured to perform the example masking strategy method 300.

To alleviate a complicated searching problem and to automatically learn mask placement, a learnable scale factor α∈(0,1) may be introduced for each attention head. Such a technique is referred to herein Soft Masking in which 0s in an original mask are replaced by scale factors while is are kept as is. The term Hard Masking is used herein for the original-type masks that use 0s and Is. Equations (4A) and (4B) respectively provide a definition for Hard Masking and Soft Masking.

$${M}_{n , j} = \{ \begin{matrix}1 & if j is a close neighbor of n \\ 0 & i f j is not a close neighbor of n\end{matrix} , and \qquad ( 4 A )$$

$${M}_{n , j}^{′} = \{ \begin{matrix}1 & if j is a close neighbor of n \\ α & i f j is not a close neighbor of n\end{matrix} , \qquad ( 4 B )$$

in which M_{n,j} and M′_{n,j} are the nth row and the j^{th} column in a hard mask and a soft mask, respectively.

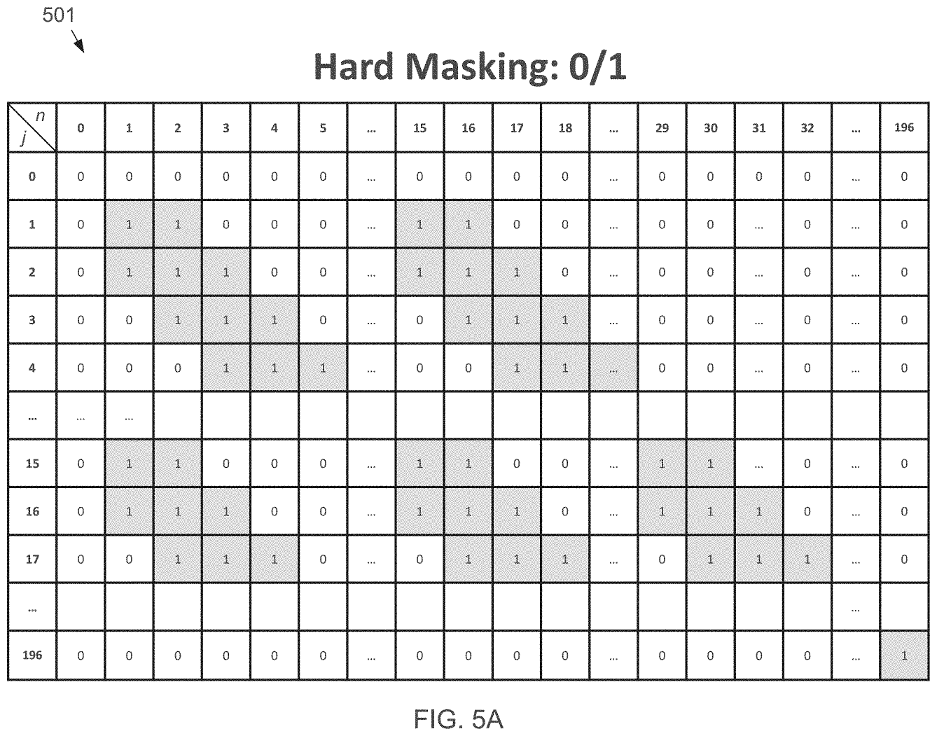

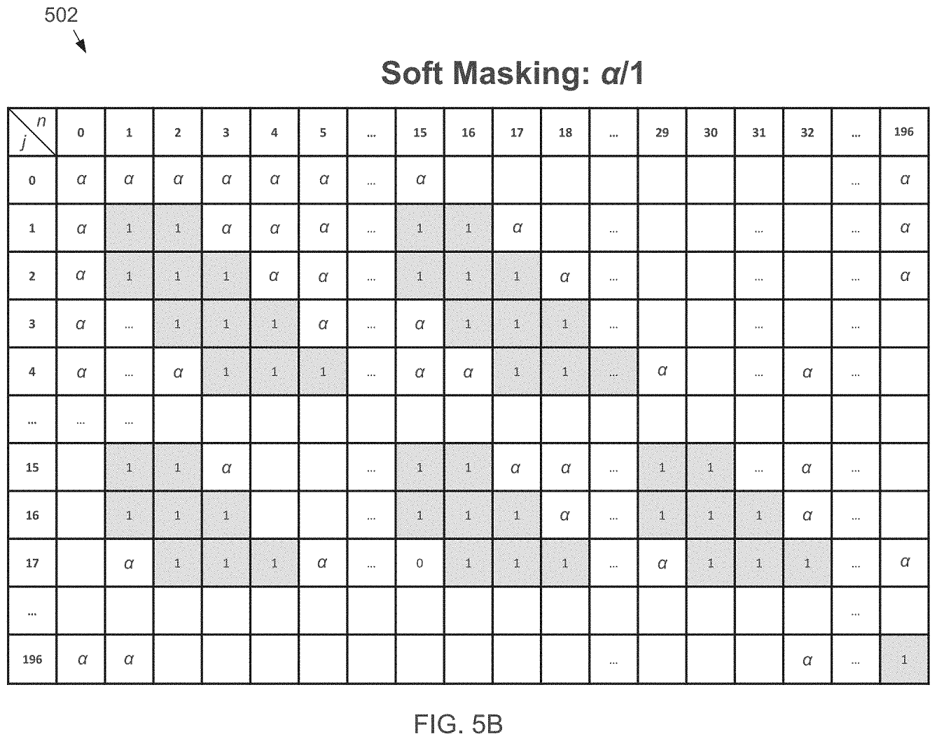

FIGS. 5A and 5B respectively depict an example hard mask 501 and an example soft mask 502 according to the subject matter disclosed herein. The scale factor α operates to penalize the attention weights from non-neighboring patches. The scale factor α allows patch tokens to contribute differently to spatial locality. For example, when α approaches 0, an attention head focuses more on local information for a patch. Otherwise, when α is close to 1, the attention head attends global information for a patch. As a result, each attention head at every layer is able to flexibly determine the importance of locality. While Soft Masking appears to add extra parameters during training, in actuality the number of additional parameters are relatively negligible. For example, only 36 extra parameters are introduced for a 12-layer MaiT tiny model having three heads.

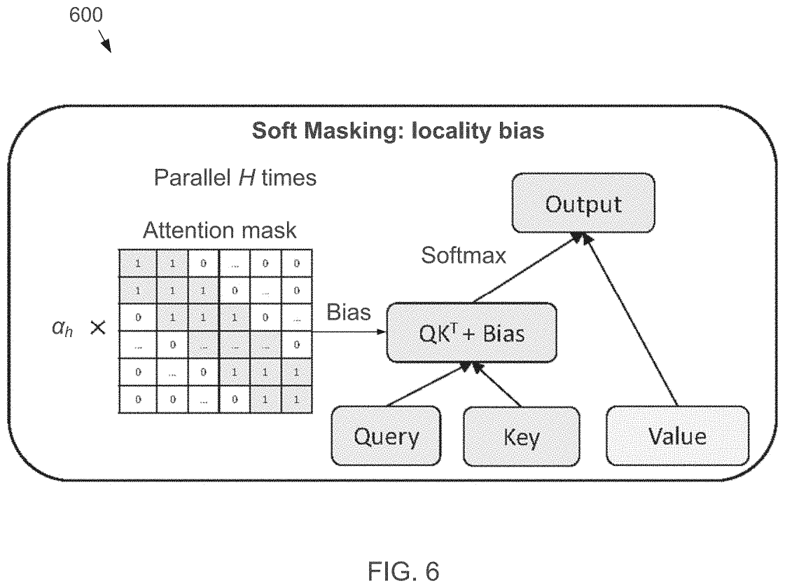

FIG. 6 depicts how soft masking may be applied to an attention head 500 according to the subject matter disclosed herein. Soft masking enhances the spatial locality in the attention map while preserve the capacity and flexibility of transformers by adding a learnable locality bias α for each attention head. The locality bias α is only added to the diagonal elements of the attention map, reinforcing the close neighbors as depicted in FIG. 6. The attention map changes accordingly as following:

$$Attention ( K ; Q ; V ) = Softmax ( \frac{Q {K}^{T}}{\sqrt{d}} + M ⨯ α ) V \qquad ( 5 )$$

in which M is the attention mask, and a is the shared bias for each attention head. The learnable bias α enables each attention head at every layer to flexibly determine the importance of locality. This also may alleviate an issue with determining the best locations among the heads for attention masks associated with pure masking.

A key feature of the subject matter disclosed herein is applying attention masks to encode spatial locality into transformers as shown in FIG. 1. The attention mask forces the attention maps to focus on close neighbors. Additionally, for better performances, the subject matter disclosed herein also may include an upgrade with spatial bias, as depicted in FIG. 2. The spatial bias term may be added to the attention mask to enhance the weights from close neighbors.

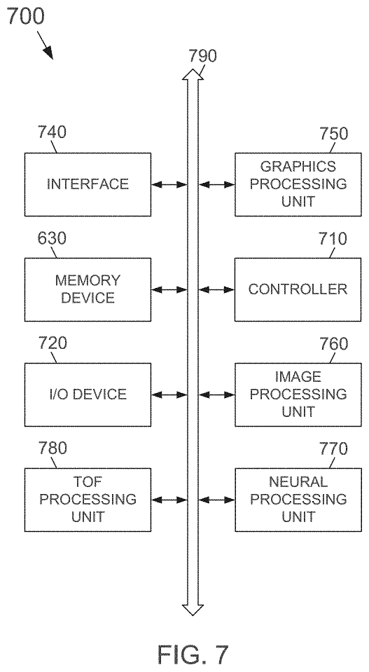

FIG. 7 depicts an electronic device 700 that includes an image transformer with attention masks according to the subject matter disclosed herein. The electronic device 700 may include a controller (or CPU) 710, an input/output device 720 such as, but not limited to, a keypad, a keyboard, a display, a touch-screen display, a 2D image sensor, a 3D image sensor, a memory 730, an interface 740, a GPU 750, an imaging-processing unit 760, a neural processing unit 770, a TOF processing unit 780 that are coupled to each other through a bus 790. The controller 710 may include, for example, at least one microprocessor, at least one digital signal processor, at least one microcontroller, or the like. The memory 730 may be configured to store a command code to be used by the controller 710 and/or to store a user data. At least one of the image-processing unit 760 or the neural processing unit 770 includes an image transformer with attention masks according to the subject matter disclosed herein.

Electronic device 700 and the various system components of electronic device 700 may be formed from one or modules. The interface 740 may be configured to include a wireless interface that is configured to transmit data to or receive data from, for example, a wireless communication network using a RF signal. The wireless interface 740 may include, for example, an antenna. The electronic system 700 also may be used in a communication interface protocol of a communication system, such as, but not limited to, Code Division Multiple Access (CDMA), Global System for Mobile Communications (GSM), North American Digital Communications (NADC), Extended Time Division Multiple Access (E-TDMA), Wideband CDMA (WCDMA), CDMA2000, Wi-Fi, Municipal Wi-Fi (Muni Wi-Fi), Bluetooth, Digital Enhanced Cordless Telecommunications (DECT), Wireless Universal Serial Bus (Wireless USB), Fast low-latency access with seamless handoff Orthogonal Frequency Division Multiplexing (Flash-OFDM), IEEE 802.20, General Packet Radio Service (GPRS), iBurst, Wireless Broadband (WiBro), WiMAX, WiMAX-Advanced, Universal Mobile Telecommunication Service-Time Division Duplex (UMTS-TDD), High Speed Packet Access (HSPA), Evolution Data Optimized (EVDO), Long Term Evolution-Advanced (LTE-Advanced), Multichannel Multipoint Distribution Service (MMDS), Fifth-Generation Wireless (5G), Sixth-Generation Wireless (6G), and so forth.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A vision transformer, comprising:
L layers; and
H attention heads in each layer in which h′ of the attention heads comprise an attention mask added before a Softmax operation, and h of the attention heads comprise unmasked attention heads, and in which H=h′+h.

2. The vision transformer of claim 1, wherein at least one attention mask multiplies a Query vector and a Key vector to form element-wise products.

3. The vision transformer of claim 2, wherein at least one attention mask comprises a 3×3 attention mask.

4. The vision transformer of claim 2, wherein at least one attention mask comprises a 5×5 attention mask.

5. The vision transformer of claim 2, wherein at least one attention mask comprises a hard mask that selects closest neighbors of a patch and ignores patches further away than the closest neighbors of the patch.

6. The vision transformer of claim 2, wherein at least one attention mask comprises a soft mask that multiplies weights of closest neighbors of a patch by a magnification factor and passes weights of patches that are further away than the closest neighbors of the patch.

7. The vision transformer of claim 2, wherein a learnable bias α is added to at least one attention mask.

8. The vision transformer of claim 7, wherein the learnable bias α is added to diagonal elements of the at least one attention map.

9. A method of integrating spatial locality into an image transformer, the method comprising:
adding an attention mask to a selected attention head in each layer of the image transformer;
determining an attention locality score for each layer of the image transformer;
adding an attention mask to all attention heads of a layer based on the attention locality score for the layer being greater than 0.75;
adding no more attention masks to a layer based on the attention locality score for the layer being greater than or equal to 0.35 and less than or equal to 0.75; and
removing the attention mask from a layer based on the attention locality score for the layer being less than 0.35.

10. The method of claim 9, wherein adding the attention mask to the selected attention head in each layer of the image transformer comprises adding the attention head before a Softmax operation.

11. The method of claim 9, wherein adding an attention mask to all attention heads of a layer based on the attention locality score for the layer being greater than 0.75 further comprises:
determining an attention locality score for each attention head in the layer; and
removing the attention mask from an attention head based on the attention locality score being less than 0.35.

12. The method of claim 9, wherein at least one attention mask comprises a 3×3 attention mask.

13. The method of claim 9, wherein at least one attention mask comprises a 5×5 attention mask.

14. The method of claim 9, wherein at least one attention mask comprises a hard mask that selects closest neighbors of a patch and ignores patches further away than the closest neighbors of the patch.

15. The method of claim 9, wherein at least one attention mask comprises a soft mask that multiplies weights of closest neighbors of a patch by a magnification factor and passes weights of patches that are further away than the closest neighbors of the patch.

16. The method of claim 9, further comprising adding a learnable bias a to at least one attention mask.

17. The method of claim 16, wherein the learnable bias α is added to diagonal elements of the at least one attention map.

18. The method of claim 9, further comprising using a cross-layer cosine similarity to evaluate an impact of at least one attention masks across at least two layers of the image transformer.
